(19) United States
(12) Patent Application Publication
(10) Pub. No.: US 2026/0341283 A1
(43) Pub. Date: Oct. 29, 2026

(54) GENERATION OF MULTICHANNEL AUDIO SIGNAL

(71) Applicant: KONINKLIJKE PHILIPS N.V., EINDHOVEN (NL)

(72) Inventors: Erik Gosuinus Petrus Schuijers, Breda (NL); Alessio Gallucci, Eindhoven (NL)

(21) Appl. No.: 19/110,143

(22) PCT Filed: Aug. 29, 2023
(86) PCT No.: PCT/EP2023/073575

§ 371 Date: Mar. 10, 2025

(30) Foreign Application Priority Data
Sep. 13, 2022 (EP) 22195261.7

(51) Int. Cl. G10L 19/008

(52) U.S. Cl. CPC G10L 19/008

(57) ABSTRACT

An audio apparatus comprises a receiver (101) arranged to receive a downmix audio signal for a multichannel audio signal and upmix parametric data for upmixing the downmix audio signal. A first artificial neural network (107) generates a set of feature values for the downmix audio signal from samples of the downmix audio signal. A second artificial neural network (109) has input nodes receiving second samples of the downmix audio signal and nodes receiving feature values from the set of feature values. Based on these inputs, the second artificial neural network (109) generates samples of an auxiliary audio signal for the downmix audio signal. A generator (105) generates the multichannel audio signal from the downmix signal and the auxiliary audio signal in dependence on the upmix parametric data. In many embodiments, the operation may be subband based with separate artificial neural networks being used for different subbands.

### FIELD OF THE INVENTION

The invention relates to generation of multichannel audio signals and in particular, but not exclusively, to generation of stereo signals from upmixing of a mono downmix signal using upmix parametric data.

### BACKGROUND OF THE INVENTION

Spatial audio applications have become numerous and widespread and increasingly form at least part of many audiovisual experiences. Indeed, new and improved spatial experiences and applications are continuously being developed which results in increased demands on the audio processing and rendering.

For example, in recent years, Virtual Reality (VR) and Augmented Reality (AR) have received increasing interest and a number of implementations and applications are reaching the consumer market. Indeed, equipment is being developed for both rendering the experience as well as for capturing or recording suitable data for such applications. For example, relatively low-cost equipment is being developed for allowing gaming consoles to provide a full VR experience. It is expected that this trend will continue and indeed will increase in speed with the market for VR and AR reaching a substantial size within a short time scale. In the audio domain, a prominent field explores the reproduction and synthesis of realistic and natural spatial audio. The ideal aim is to produce natural audio sources such that the user cannot recognize the difference between a synthetic or an original one.

A lot of research and development effort has focused on providing efficient and high-quality audio encoding and audio decoding for spatial audio. A frequently used spatial audio representation is multichannel audio representations, including stereo representation, and efficient encoding of such multichannel audio based on downmixing multichannel audio signals to downmix channels with fewer channels have been developed. One of the main advances in low bit-rate audio coding has been the use of parametric multichannel coding where a downmix signal is generated together with parametric data that can be used to upmix the downmix signal to recreate the multichannel audio signal.

In particular, instead of traditional mid-side or intensity coding, in parametric multichannel audio coding a multichannel input signal is downmixed to a lower number of channels (e.g. two to one) and multichannel image (stereo) parameters are extracted. Then the downmix signal is encoded using a more traditional audio coder (e.g. a mono audio encoder). The bitstream of the downmix is multiplexed with the encoded multichannel image parameter bitstream. This bitstream is then transmitted to the decoder, where the process is inverted. First the downmix audio signal is decoded, after which the multichannel audio signal is reconstructed guided by the encoded multichannel image upmix parameters.

An example of stereo coding is described in E. Schuijers, W. Oomen, B. den Brinker, J. Breebaart, “Advances in Parametric Coding for High-Quality Audio”, 114th AES Convention, Amsterdam, The Netherlands, 2003, Preprint 5852. In the described approach, the downmixed mono signal is parametrized by exploiting the natural separation of the signal into three components (objects): transients, sinusoids, and noise. In E. Schuijers, J. Breebaart, H. Purnhagen, J. Engdegård, “Low Complexity Parametric Stereo Coding”, 116th AES, Berlin, Germany, 2004, Preprint 6073 more details are provided describing how parametric stereo was realized with a low (decoder) complexity when combining it with Spectral Band Replication (SBR).

In the described approaches, the decoding is based on the use of the so-called de-correlation process. The de-correlation process generates a decorrelated helper signal from the monaural signal. In the stereo reconstruction process, both the monaural signal and the decorrelated helper signal are used to generate the upmixed stereo signal based on the upmix parameters. Specifically, the two signals may be multiplied by a time- and frequency-dependent 2×2 matrix having coefficients determined from the upmix parameters to provide the output stereo signal.

However, although Parametric Stereo (PS) and similar downmix encoding/decoding approaches were a leap forward from traditional stereo and multichannel coding, the approach is not optimal in all scenarios. In particular, known encoding and decoding approaches tend to introduce some distortion, changes, artefacts etc. that may introduce differences between the (original) multichannel audio signal input to the encoder and the multichannel audio signal recreated at the decoder. Typically, the audio quality may be degraded and imperfect recreation of the multichannel occurs. Further, the data rate may still be higher than desired and/or the complexity/resource usage may of the processing may be higher than preferred.

Hence, an improved approach would be advantageous. In particular, an approach allowing increased flexibility, improved adaptability, an improved performance, increased audio quality, improved audio quality to data rate trade-off, reduced complexity and/or resource usage, reduced computational load, facilitated implementation and/or an improved spatial audio experience would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an apparatus for generating a multichannel audio signal, the apparatus comprising: a receiver arranged to receive a downmix audio signal for the multichannel audio signal and upmix parametric data for upmixing the downmix audio signal; a first artificial neural network arranged to generate a set of feature values for the downmix audio signal, the first artificial neural network having input nodes for receiving first samples of the downmix audio signal and output nodes for providing the set of feature values; a second artificial neural network having input nodes for receiving second samples of the downmix audio signal and output nodes arranged to provide samples of an auxiliary audio signal for the downmix audio signal, the second artificial neural network further comprising nodes receiving feature values from the set of feature values; and a generator arranged to generate the multichannel audio signal from the downmix signal and the auxiliary audio signal in dependence on the upmix parametric data.

The approach may provide an improved audio experience in many embodiments. For many signals and scenarios, the approach may provide improved generation/reconstruction of a multichannel audio signal with an improved perceived audio quality. The approach may provide a particularly advantageous arrangement which may in many embodiments and scenarios allow a facilitated and/or improved possibility of utilizing artificial neural networks in audio processing, including typically audio encoding and/or decoding. The approach may allow an advantageous employment of artificial neural network(s) in generating a multichannel audio signal from a downmix audio signal.

The approach may provide an efficient implementation and may in many embodiments allow a reduced complexity and/or resource usage. The approach may in many scenarios allow a reduced data rate for data representing a multichannel audio signal using a downmix signal.

The first samples and the second samples may be the same samples or may be different samples (or may be partially the same samples). The first samples and the second samples may be time domain samples, may be frequency domain samples, or may span a particular time and frequency range (specifically subband domain samples). The samples of an auxiliary audio signal may be time domain samples, may be frequency domain samples, or may span a particular time and frequency range (specifically subband domain samples).

The upmix parametric data may comprise parameter (values) relating properties of the downmix signal to properties of the multichannel audio signal. The upmix parametric data may comprise data being indicative of relative properties between channels of the multichannel audio signal. The upmix parametric data may comprise data being indicative of differences in properties between channels of the multichannel audio signal. The upmix parametric data may comprise data being perceptually relevant for the synthesis of the multichannel audio signal. The properties may for example be differences in phase and/or intensity and/or timing and/or correlation. The upmix parametric data may in some embodiments and scenarios represent abstract properties not directly understandable by a human person/expert (but may typically facilitate a better reconstruction/lower data rate etc). The upmix parametric data may comprise data including at least one of interchannel intensity differences, interchannel timing differences, interchannel correlations and/or interchannel phase differences for channels of the multichannel audio signal.

The first and second artificial neural networks are trained artificial neural networks.

The first and/or second artificial neural network may be a trained artificial neural network(s) trained by training data including training downmix audio signals and training upmix parametric data generated from training multichannel audio signals; the training employing a cost function comparing the training multichannel audio signals to upmixed multi-channel signals generated, using the training upmix parametric data, from the training downmix signals and generated auxiliary audio signals. The first and/or second artificial neural network may be a trained artificial neural network(s) trained by training data including training data representing a range of relevant audio sources including recording of videos, movies, telecommunications, etc.

The first and/or second artificial neural network may be a trained artificial neural network(s) trained by training data having training input data comprising training downmix audio signals of training multichannel audio signals, and using a cost function including a contribution indicative of a difference between training auxiliary audio signals generated by the second artificial neural network in response to the training data and training residual signals for the training downmix audio signals.

The generator may be arranged to generate the multichannel audio signal by applying a matrix multiplication to the downmix signal and the auxiliary audio signal with the coefficients of the matrix being determined as a function of parameters of the upmix parametric data. The matrix be time- and frequency-dependent.

The audio apparatus may specifically be an audio decoder apparatus.

According to an optional feature of the invention, that apparatus comprises a first filter bank for generating a frequency subband representation of the downmix audio signal; and wherein at least some of the second samples of the downmix audio signal are subband samples of the frequency subband representation.

Subband processing may provide a particularly advantageous operation in many embodiments. The arrangement may be particularly suited for subband processing which may allow reduced complexity and/or and improved multichannel audio signal to be generated.

According to an optional feature of the invention, the second artificial neural network is a artificial neural network of a first plurality of subband artificial neural networks, each subband artificial neural network of the first plurality of subband artificial neural networks being arranged to generate subband samples for a subset of subbands of a frequency subband representation of the auxiliary audio signal.

A particular advantage of the approach is that it may allow highly efficient subband processing thereby allowing partitioning of the required processing into a plurality of smaller artificial neural networks. This may typically allow reduced complexity and/or an improved multichannel audio signal to be generated.

In many embodiments, each (or at least some) subband neural network(s) is arranged to generate subband samples for one subband of the frequency subband representation of the auxiliary audio signal.

According to an optional feature of the invention, the plurality of subband artificial neural networks includes an artificial neural network for each subband of the frequency subband representation of the auxiliary audio signal.

This may in many embodiments and scenarios provide a highly advantageous and efficient implementation and/or operation and/or performance.

According to an optional feature of the invention, the generator is arranged to generate a frequency subband representation of the multichannel audio signal by applying a subband matrix operation to the frequency subband representation of the auxiliary audio signal and the frequency subband representation of the downmix audio signal, and to transform the frequency subband representation of the multichannel audio signal to a time domain representation of the multichannel audio signal.

This may in many embodiments and scenarios provide a highly advantageous and efficient implementation and/or operation and/or performance.

According to an optional feature of the invention, the set of feature values generated by a subband artificial neural network of the first plurality of subband artificial neural networks is common for a plurality of subbands of the frequency subband representation of the downmix audio signal.

This may provide a particularly efficient implementation and/or improved performance.

The set of feature values generated by the subband neural network and being common for a plurality of subbands may be input to a plurality of subband artificial neural networks generating the multichannel audio signal (and specifically the second artificial neural network may be one of a plurality of artificial neural networks having nodes receiving the common set of feature values).

According to an optional feature of the invention, a number of input nodes for artificial neural networks of the first plurality of subband artificial neural networks is monotonically decreasing for increasing frequency.

This may provide a particularly efficient implementation and/or improved performance.

According to an optional feature of the invention, the apparatus comprises a second filter bank for generating a frequency subband representation of the downmix audio signal; and wherein at least some of the first samples of the downmix audio signal are subband samples of the frequency subband representation.

This may provide a particularly efficient implementation and/or improved performance.

Subband processing may provide a particularly advantageous operation in many embodiments. The arrangement may be particularly suited for subband processing which may allow reduced complexity and/or and improved multichannel audio signal to be generated.

The first filter bank and the second filter bank may be the same or different. The subband representation of the downmix audio signal generated by the first filter bank and fed to the first plurality of subbands may use the same subbands as the subband representation of the downmix audio signal generated by the second filter bank and fed to the second plurality of subbands, or may in some embodiments be different.

According to an optional feature of the invention, the first artificial neural network is an artificial neural network of a second plurality of subband artificial neural networks, each subband artificial neural network of the second plurality of subband artificial neural networks being arranged to generate subband samples for a subset of artificial neural networks of the first plurality of artificial neural networks.

A particular advantage of the approach is that it may allow highly efficient subband processing thereby allowing partitioning of the required processing into a plurality of (potentially smaller) artificial neural networks. This may typically allow reduced complexity and/or an improved multichannel audio signal to be generated.

According to an optional feature of the invention, subband samples of the second subband samples for at least one artificial neural network of the second plurality of artificial neural networks include a plurality of subband samples for multiple processing time intervals of an artificial neural network of the first plurality of artificial neural networks.

This may provide a particularly efficient implementation and/or improved performance.

According to an optional feature of the invention, subband samples of the second subband samples for at least one artificial neural network of the second plurality of artificial neural networks include at least one subband sample for a subband of the subband representation of the downmix audio signal for which the at least one artificial neural network does not generate subband samples for the subband representation of the auxiliary audio signal.

This may provide a particularly efficient implementation and/or improved performance.

According to an optional feature of the invention, the first artificial neural network and the second artificial neural network are trained by a joint training process based on training data comprising sets of samples of a downmix audio signal generated by downmixing a training multichannel audio signal and a target audio signal determined from a residual signal generated for the downmix audio signal, and using a cost function indicative of a difference of a generated auxiliary audio signal for the training multichannel audio signal and the target audio signal.

This may provide a particularly efficient implementation and/or improved performance.

According to an optional feature of the invention, the apparatus comprises generating feature values for the set of feature values from analytical analysis of the downmix audio signal.

This may provide a particularly efficient implementation and/or improved performance.

According to an aspect of the invention, there is provided method of generating a multichannel audio signal, the method comprising: receiving a downmix audio signal for the multichannel audio signal and upmix parametric data for upmixing the downmix audio signal; a first artificial neural network generating a set of feature values for the downmix audio signal, the first artificial neural network having input nodes for receiving first samples of the downmix audio signal and output nodes for providing the set of feature values; a second artificial neural network having input nodes for receiving second samples of the downmix audio signal and output nodes providing samples of an auxiliary audio signal for the downmix audio signal, the second artificial neural network further comprising nodes receiving feature values from the set of feature values; and generating the multichannel audio signal from the downmix signal and the auxiliary audio signal in dependence on the upmix parametric data.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates some elements of an example of an audio apparatus in accordance with some embodiments of the invention;

FIG. 2 illustrates an example of a structure of an artificial neural network;

FIG. 3 illustrates an example of a node of an artificial neural network;

FIG. 4 illustrates some elements of an example of an audio apparatus in accordance with some embodiments of the invention;

FIG. 5 illustrates some elements of an example of an audio apparatus in accordance with some embodiments of the invention;

FIG. 6 illustrates some elements of an example of an apparatus for training artificial neural networks of an audio apparatus in accordance with some embodiments of the invention; and

FIG. 7 illustrates some elements of a possible arrangement of a processor for implementing elements of an audio apparatus in accordance with some embodiments of the invention.

### DETAILED DESCRIPTION OF SOME EMBODIMENTS OF THE INVENTION

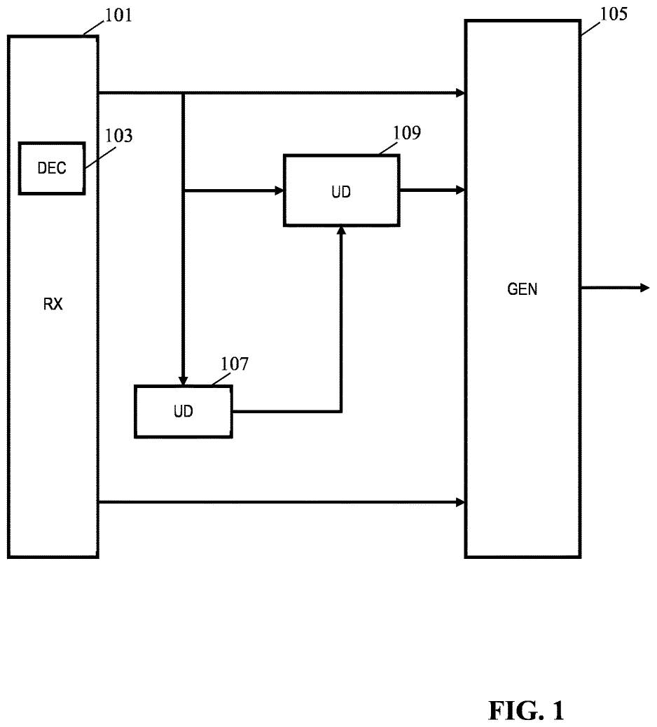

FIG. 1 illustrates some elements of an audio apparatus in accordance with some embodiments of the invention.

The audio apparatus comprises a receiver 101 which is arranged to receive a data signal/bitstream comprising a downmix audio signal which is a downmix of a multichannel audio signal. The following description will focus on a case where the multichannel audio signal is a stereo signal and the downmix signal is a mono signal, but it will be appreciated that the described approach and principles are equally applicable to the multichannel audio signal having more than two channels and to the downmix signal having more than a single channel (albeit fewer channels than the multichannel audio signal).

In addition, the received data signal includes upmix parametric data for upmixing the downmix audio signal. The upmix parametric data may specifically be a set of parameters that indicate relationships between the signals of different audio channels of the multichannel audio signal (specifically the stereo signal) and/or between the downmix signal and audio channels of the multichannel audio signal. Typically, the upmix parameters may be indicative of time differences, phase differences, level/intensity differences and/or a measure of similarity, such as correlation. Typically, the upmix parameters are provided on a per time and per frequency basis (time frequency tiles). For example, new parameters may periodically be provided for a set of subbands. Parameters may specifically include Inter-channel phase difference (IPD), Overall phase difference (OPD), Inter-channel correlation (ICC), Channel phase difference (CPD) parameters as known from Parametric Stereo encoding (as well as from higher channel encodings).

Typically, the downmix audio signal is encoded and the receiver 101 includes a decoder 103 that decodes the downmix audio signal, i.e. the mono signal in the specific example. It will be appreciated that the decoder 103 may not be needed in case the received downmix audio signal is not encoded and that the decoder 103 may be considered to be an integral part of the receiver 101.

The receiver 101 is coupled to a generator 105 which generates the multichannel audio signal from the downmix signal. The generator 105 is arranged to generate the multichannel audio signal from the downmix audio signal as well as from an auxiliary audio signal in dependence on the parametric upmix data. The generator may specifically for the stereo case generate the output multichannel audio signal by applying a 2×2 matrix multiplication to the samples of the downmix audio signal and the auxiliary audio signal. The coefficients of the 2×2 matrix are determined from the upmix parameters of the upmix parametric data, typically on a time and frequency band basis. For other upmix operations, such as from a mono or stereo downmix signal to a five channel multichannel audio signal, the generator 105 may apply matrix multiplications with matrices of suitable dimensions.

It will be appreciated that many different approaches of generating such a multichannel audio signal from a downmix audio signal and an auxiliary audio signal, and for determining suitable matrix coefficients from upmix parametric data, will be known to skilled person and that any suitable approach may be used. Specifically, various approaches for Parametric Stereo upmixing that are based on downmix and auxiliary audio signals are well known to the skilled person.

In conventional systems, the upmixing includes generating an auxiliary audio signal in the form of a decorrelated signal of the mono audio signal. It has been found that by generating a decorrelated signal and mixing this with the mono audio signal, an improved quality of the upmix signal is perceived and therefore decoders have been developed to exploit this. The decorrelated signal is typically generated by a decorrelator in the form of an all-phase filter that is applied to the mono audio signal. However, whereas the use of such an all pass filter tends to result in a multichannel audio signal being generated that is perceived to be of improved quality, it is still not ideal, and some audio quality degradation may often be perceived.

The audio apparatus of FIG. 1 uses an approach which has been found to tend to provide an improved perceived audio quality in many scenarios and for many different audio signals.

In the approach, a decorrelated signal is not generated by a straightforward filtering of the downmix/mono audio signal, but rather an auxiliary audio signal is generated by a specific arrangement of trained artificial neural networks with the auxiliary audio signal being used by the generator 105 to generate the multichannel audio signal based on the upmix parameters.

The apparatus of FIG. 1 specifically comprises a first artificial neural network 107 which is arranged to receive samples of the downmix audio signal with these being fed to input nodes of the first artificial neural network. The output nodes of the first artificial neural network 107 provide a set of feature values for the downmix audio signal. The set of feature values may comprise a number of values (such as specifically scalar values) that are reflective of properties or characteristics of the downmix audio signal. Typically, the first artificial neural network 107 may comprise a much larger number of input nodes than output nodes, and consequently a relatively low number of feature values are generated from a relatively large number of samples. Accordingly, the feature values may provide a highly compressed and reduced representation of some properties or characteristics of the downmix audio signal. For example, the first artificial neural network 107 may have 1028 input nodes and 16 output nodes thereby providing a highly compressed set of values that are dependent on properties of the downmix audio signal.

The apparatus further comprises a second artificial neural network 109 which is coupled to the first neural network and to the decoder 103/receiver 105. The second artificial neural network 109 specifically comprises input nodes for receiving samples of the downmix audio signal. Further, the second artificial neural network 109 comprises nodes that receive contributions from the feature values of the set of feature values generated by the first artificial neural network 107. Such nodes may be input nodes of the input layer that also comprises the nodes receiving the samples of the downmix audio signal or one, more, or all of the nodes receiving the feature values may be nodes of a different layer than the input layer of the downmix audio signal. For example, some or all of the nodes receiving contributions from feature values may be part of a hidden or processing layer of the second artificial neural network 109.

The second artificial neural network 109 has output nodes that provide samples of the auxiliary audio signal and these may then be fed to the generator 105 where the upmix operation is completed.

In the approach, the upmix process is thus not based on applying a decorrelation filter to the downmix audio signal in order to generate a decorrelated signal that is subsequently combined with the downmix audio signal to generate the multichannel audio signal. Rather, a structure of trained artificial neural networks generates an auxiliary audio signal that may specifically replace the decorrelated signal used in conventional upmix decoders. Both the first artificial neural network 107 and the second artificial neural network 109 have input nodes that receive samples of the downmix audio signal but in addition the output of the first artificial neural network 107 is introduced to the second artificial neural network 109 and is thus used to control and adapt the processing of the second artificial neural network 109. Thus, even of constant weights and coefficients, the second artificial neural network 109 is not merely a fixed filter or trained network but rather can be seen as being an adaptive or variable operation that is adapted based on the results of the first artificial neural network 107.

As will be described in detail later, different approaches may be used to train the neural networks and in particular an overall training may seek to result in the output of the audio apparatus being a multichannel audio signal that most closely correspond to the original multichannel audio signal. Thus, the arrangement may be trained to provide an auxiliary audio signal that most effectively results in accurate reconstruction of the multichannel audio signal. In contrast to conventional approaches, such a signal is not necessarily a decorrelated signal but rather the second artificial neural network 109 will be trained to result in an auxiliary audio signal that is most suitable for the combination with the downmix audio signal to generate the multichannel audio signal. Such a signal will typically not be a decorrelated signal of the downmix audio signal but may for example be a partially correlated signal, and indeed in many cases may be likely to be closer to the actual residual signal that results from the original downmixing of the multichannel audio signal. Thus, the user of a trained artificial neural network may allow the decoder to inherently and automatically take into account and compensate for effects that may be introduced at the encoder side.

Similarly, the first artificial neural network 107 and the generated features are not specifically feature values that represent specific properties or characteristics of the signal that will have significance to humans. Rather, the first artificial neural network 107 may be trained such that it automatically adapts to provide feature values that are particularly suitable for adapting the second artificial neural network 109 to provide improved output values for accurate reproduction of the multichannel audio signal.

In the approach, the artificial neural network arrangement is accordingly arranged to generate a second auxiliary “helper” signal that aids and improves the multichannel reconstruction. E.g. for a stereo signal, the encoder may generate a downmix signal as c*(1+r), where l,r represent the left channel signal and the right channel signal respectively and c is a time- and frequency-dependent scaling factor. The corresponding second signal for ideal reconstruction can be shown to be d*(1−r), where d is again time- and frequency-dependent. Those two signals are not necessarily fully decorrelated and a substantial advantage of the described approach is that in contrast to merely seeking to try decorrelate the mono-downmix, the artificial neural network arrangement will generate an auxiliary audio signal that will tend to approach the ideal signal d*(1−r). This may typically provide substantially improved reconstruction of the original multichannel audio signal.

The generating of the auxiliary audio signal is further improved by the second artificial neural network 109 generating this signal being adapted based on the set of feature values generated by the first artificial neural network 107. This adaptation has been found to improve the reconstruction substantially relative to scenarios where adaption is not included.

Further, the specific arrangement allows for a very efficient implementation which may be achieved with relatively low complexity and resource usage.

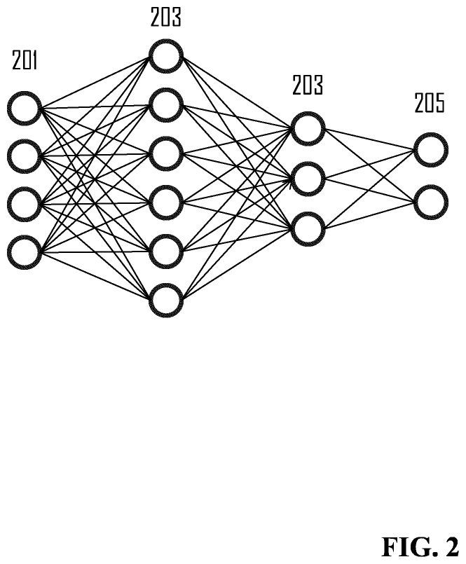

An artificial neural network as used in the described functions may be a network of nodes arranged in layers and with each node holding a node value. FIG. 2 illustrates an example of a section of an artificial neural network.

The node value for a given node may be calculated to include contributions from some or often all nodes of a previous layer of the artificial neural network. Specifically, the node value for a node may be calculated as a weighted summation of the node values of all the nodes output of the previous layer. Typically, a bias may be added and the result may be subjected to an activation function. The activation function provides an essential part of each neuron by typically providing a non-linearity. Such non-linearities and activation functions provides a significant effect in the learning and adaptation process of the neural network. Thus, the node value is generated as a function of the node values of the previous layer.

The artificial neural network may specifically comprise an input layer 201 comprising a plurality of nodes receiving the input data values for the artificial neural network. Thus, the node values for nodes of the input layer may typically directly be the input data values to the artificial neural network and thus may not be calculated from other node values.

The artificial neural network may further comprise none, one, or more hidden layers 203 or processing layers. For each of such layers, the node values are typically generated as a function of the node values of the nodes of the previous layer, and specifically a weighted combination and added bias followed by an activation function (such as a sigmoid, ReLU, or Tanh function may be applied).

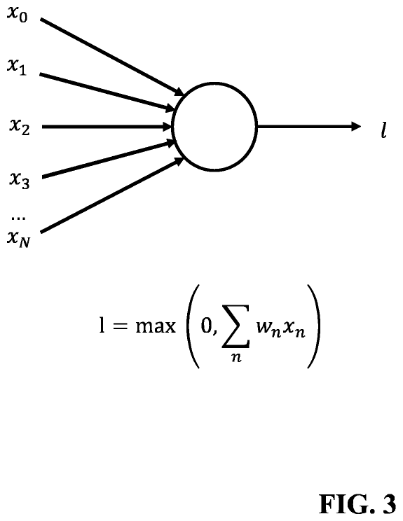

Specifically, as shown in FIG. 3, each node, which may also be referred to as a neuron, may receive input values (from nodes of a previous layer) and therefrom calculate a node value as a function of these values. Often, this includes first generating a value as a linear combination of the input values with each of these weighted by a weight:

$$k = {\sum }_{n} {w}_{n} {x}_{n}$$

where w refers to weights, x refers to the nodes of the previous layer and n is an index referring to the different nodes of the previous layer.

An activation function may then be applied to the resulting combination. For example, the node value 1 may be determined as:

l=ƒ(k)

where the function may for example be a Rectified Linear Unit (as described in Xavier Glorot, Antoine Bordes, Yoshua Bengio Proceedings of the Fourteenth International Conference on Artificial Intelligence and Statistics, PMLR 15:315-323, 2011) function:

ƒ(k)=ReLU(k)=max(0,k)

Other often used functions include a sigmoid function or a tanh function. In many embodiments, the node output or value may be calculated using a plurality of functions. For example, both a ReLU and Sigmoid function may be combined using an activation function such as:

ƒ(k)=ReLU(k)+σ(k)

Such operations may be performed by each node of the artificial neural network (except for typically the input nodes).

The artificial neural network further comprises an output layer 205 which provides the output from the artificial neural network, i.e. the output data of the artificial neural network is the node values of the output layer. As for the hidden/processing layers, the output node values are generated by a function of the node values of the previous layer. However, in contrast to the hidden/processing layers where the node values are typically not accessible or used further, the node values of the output layer are accessible and provide the result of the operation of the artificial neural network.

A number of different networks structures and toolboxes for artificial neural network have been developed and in many embodiments the artificial neural network may be based on adapting and customizing such a network. An example of a network architecture that may be suitable for the applications mentioned above is WaveNet by van den Oord et al which is described in Oord, Aaron van den, Sander Dieleman, Heiga Zen, Karen Simonyan, Oriol Vinyals, Alex Graves, Nal Kalchbrenner, Andrew Senior, and Koray Kavukcuoglu. “Wavenet: A generative model for raw audio.” arXiv preprint arXiv: 1609.03499 (2016).

WaveNet is an architecture used for the synthesis of time domain signals using dilated causal convolution, and has been successfully applied to audio signals. For WaveNet the following activation function is commonly used:

z=tanh(W_{ƒ,k}*x)⊙σ(W_{g,k}*x),

where * denotes a convolution operator, ⊙ denotes an element-wise multiplication operator, σ(·) is a sigmoid function, k is the layer index, f and g denote filter and gate, respectively, and W represents the weights of the learned artificial neural network. The filter product of the equation may typically provide a filtering effect with the gating product providing a weighting of the result which may in many cases effectively allow the contribution of the node to be reduced to substantially zero (i.e. it may allow or “cut-off” the node providing a contribution to other nodes thereby providing a “gate” function). In different circumstances, the gate function may result in the output of that node being negligible, whereas in other cases it would contribute substantially to the output. Such a function may substantially assist in allowing the neural network to effectively learn and be trained.

An artificial neural network may in some cases further be arranged to include additional contributions that allow the artificial neural network to be dynamically adapted or customized for a specific desired property or characteristics of the generated output. For example, a set of values may be provided to adapt the artificial neural network. These values may be included by providing a contribution to some nodes of the artificial neural network. These nodes may be specifically input nodes but may typically be nodes of a hidden or processing layer. Such adaptation values may for example be weighted and added as a contribution to the weighted summation/correlation value for a given node. For example, for WaveNet such adaptation values may be included in the activation function. For example, the output of the activation function may be given as:

Z=tanh(W_{ƒ,k}*x+V_{ƒ,k}*y)⊙σ(W_{g,k}*x+V_{g,k}*y)

where y is a vector representing the adaptation values and V represents suitable weights for these values.

The above description relates to a neural network approach that may be suitable for many embodiments and implementations. However, it will be appreciated that many other types and structures of neural network may be used. Indeed, many different approaches for generating a neural network have been, and are being, developed including neural networks using complex structures and processes that differ from the ones described above. The approach is not limited to any specific neural network approach and any suitable approach may be used without detracting from the invention.

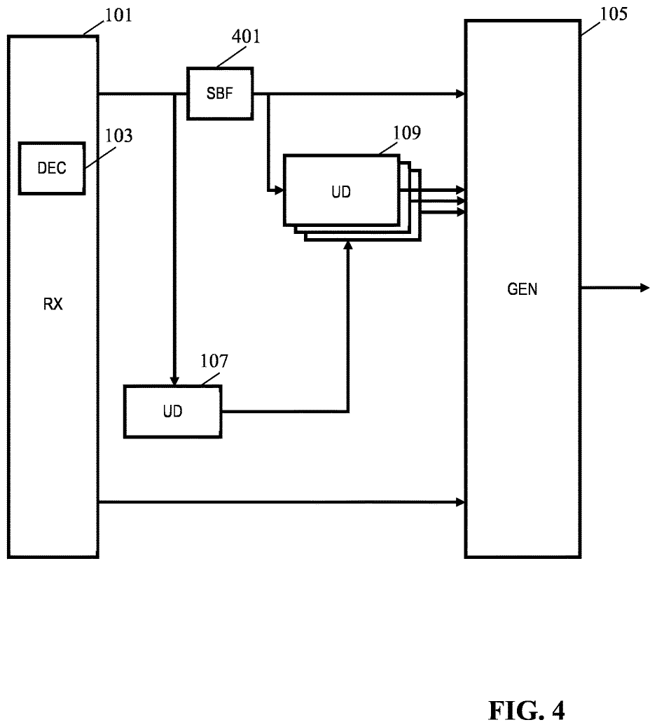

In many embodiments, the audio apparatus is arranged to perform subband processing. Specifically, as shown in FIG. 4, the apparatus of FIG. 1 may be modified to include a filter bank which is arranged to generate a frequency or subband representation of the downmix audio signal. The filter bank may be Quadrature Mirror Filter (QMF) bank or may e.g. be implemented by a Fast Fourier Transform (FFT), but it will be appreciated that many other filter banks and approaches for dividing an audio signal into a plurality of subband signals are known and may be used. The filter-bank may specifically be a complex-valued pseudo QMF bank, resulting in e.g. 32 or 64 complex-valued sub-band signals.

In many embodiments, the filterbank 401 is arranged to generate a set of subband signals for subbands having equal bandwidth. In other embodiments, the filterbank 401 may be arranged to generate subband signals with subbands having different bandwidths. For example, a higher frequency subbands may have a higher bandwidth than a lower frequency subband. Also, subbands may be grouped together to form a higher bandwidth sub-band.

Typically, the subbands may have a bandwidth in the range from 10 Hz to 10000 Hz.

In some such embodiments, an artificial neural network generating samples for the auxiliary audio signal is arranged to receive subband samples, i.e. samples of a subband audio signal. In particular, the apparatus of FIG. 4 comprises a plurality of subband neural networks 109 that are each arranged to receive subband samples for a subband generated by the filterbank from the downmix signal. Each of the subband artificial neural networks further comprises the set of feature values and it proceeds to generate subband samples of the multichannel audio signal for that subband.

The subband samples from the subband artificial neural networks are fed to the generator 105 which proceeds to generate the reconstructed multichannel audio signal/For example, in some embodiments where a subband representation of the multichannel audio signal is desired (e.g. due to a subsequent processing also being subband based), the generator 105 may simply output the subband samples from the subband artificial neural networks, possibly in accordance with a specific structure or format. In many embodiments, the generator 105 comprises functionality for converting the subband representation of the reconstructed multichannel audio signal to a time domain representation. The generator 105 may specifically comprise a synthesis filterbank performing the inverse operation of the filterbank 401 thereby converting the subband representation to a time domain representation of the multichannel audio signal.

The generator may specifically be arranged to generate a frequency/subband-domain representation of the multichannel audio signal by processing the frequency or subband-domain representation of the downmix audio signal and the frequency/subband-domain representation of the auxiliary audio signal. The processing of the generator 105 may thus be a subband processing, such as for example a matrix multiplication performed in each subband on the subband samples of the downmix audio signal and the auxiliary audio signal generated by the corresponding subband artificial neural network.

The resulting subband/frequency domain representation may then be used directly or may e.g. be converted to a time domain representation using a suitable synthesis filter bank, which in particular may be applied by separate synthesis filters for each channel.

Each of the plurality of subband neural networks may also be referred to as an auxiliary subband (domain) artificial neural network or more concisely as an auxiliary subband artificial neural network. The comments previously provided with respect to the second artificial neural network 109 will mutatis mutandis also apply to the auxiliary subband artificial neural networks, indeed the second artificial neural network 109 may be considered to be one of the auxiliary subband artificial neural networks.

Thus, in the arrangement, each of the auxiliary subband artificial neural networks receives subband samples for the subband of the auxiliary subband artificial neural networks and further all of the auxiliary subband artificial neural networks are arranged to receive the set of feature values from the first artificial neural network 107.

Each of the auxiliary subband artificial neural networks generates subband samples for a subset of subbands of a frequency subband representation of the auxiliary audio signal, and typically generates (only) subband samples for the subband for which it receives input samples from the filterbank 401.

In many embodiments, the apparatus includes an artificial neural network for each subband of the frequency subband representation of the auxiliary audio signal generated by the filter bank. Thus, in many embodiments, the output samples for each subband of the filterbank 401 is fed to input nodes of one auxiliary subband artificial neural network with that auxiliary subband artificial neural network then generating subband samples of the auxiliary audio signal for that subband. In many embodiments, the subband processing may thus be completely separated for each subband.

However, it will be appreciated that in some embodiments, auxiliary subband artificial neural networks may only be provided for none, one, or some of the subbands whereas for other subbands an auxiliary subband artificial neural networks may be employed that receives samples from multiple subbands, or indeed for some subbands no auxiliary subband artificial neural network may be applied (e.g. traditional decorrelation may be used for some subbands, such as typically for higher subbands).

In the example, the generation of the auxiliary audio signal is thus performed on a subband by subband basis with separate and individual artificial neural networks in each subband. The individual artificial neural networks are trained to provide output samples for the subband for which they are provided input subband samples. However, the subband artificial neural networks are further adapted based on the feature values generated by the first artificial neural network 107.

Such an approach has been found to provide a very advantageous generation of an auxiliary audio signal that allows a very high quality reconstruction of the multichannel audio signal. Further, it may allow a highly efficient operation with substantially reduced complexity and/or typically substantially reduced computational resource requirements. The subband artificial neural networks tend to be substantially smaller than a single full artificial neural network required for generation of the entire signal. Typically, a lot fewer nodes, and possibly even fewer layers, are required for the processing resulting in a very big reduction in the number of operations and calculations required to implement the artificial neural network functionality. Although more artificial neural networks are needed to cover all the subbands, the smaller artificial neural networks will typically result in a huge reduction in the overall number of operations required, and thus in the overall computational resource requirement. Further, in many scenarios it may allow a more efficient learning process.

The subband arrangement may accordingly provide a computationally efficient approach for allowing artificial neural networks to be implemented to assist in the decoding of audio data comprising a downmix audio signal and upmix parametric data. The described system and approach allow a high quality multichannel audio signal to be reconstructed and typically significantly improved audio quality can be achieved compared to a conventional approach. Further, a computationally efficient decoding process can be achieved. The subband and artificial neural network based approach may further be compatible with other processing using subband processing.

In some embodiments, the subband processing may be more flexible than a strict subband by subband processing. For example, in some embodiments, each auxiliary subband artificial neural network may receive subband samples from not only the subband itself but possibly also for one or more other subbands. For example, the auxiliary subband artificial neural network for one subband may in some embodiments also receive samples of the downmix audio signal from one or two neighbor/adjacent subbands. As another example, in some embodiments, one or more of the auxiliary subband artificial neural networks may also receive input samples from one or more subbands comprising harmonics (or subharmonics) for frequencies of the subband. For example, a subband around a 500 Hz center frequency may also receive frequencies from a subband around a 1000 Hz center frequency. Such additional subbands having a specific relationship to the subband of the auxiliary subband artificial neural network may provide additional information that may allow an improved auxiliary subband artificial neural network to be generated for some audio signals.

In some embodiments, all the auxiliary subband artificial neural networks may have the same properties and dimensions. In particular, in many embodiments, all the auxiliary subband artificial neural networks may have the same number of input nodes and output nodes, as well as possibly the same internal structure. Such an approach may for example be used in embodiments where all subbands have the same bandwidth.

In some embodiments, the auxiliary subband artificial neural networks may however include non-identical neural networks. In particular, in some embodiments, the number of input nodes for the auxiliary subband artificial neural networks may be different for at least two of the artificial neural networks. Thus, in some embodiments, the number of input samples being included in the determination of the output samples may be different for different subbands and auxiliary subband artificial neural networks.

In some embodiments, the number of samples/input nodes may be higher for some lower frequency subbands than for some higher frequency bands. Indeed, the number of samples/input nodes may be monotonically decreasing for increasing frequency. The lower frequency auxiliary subband artificial neural networks may thus be larger and consider more input samples than higher frequency auxiliary subband artificial neural networks. Such an approach may for example be combined with subbands having different bandwidths, such as when lower frequency subbands may have a higher bandwidth than higher frequency bandwidths.

Such an approach may in many scenarios provide an improved trade-off between the audio quality that can be achieved and the computational complexity and resource usage. It may provide a closer adaptation of the system to reflect typical characteristics of audio thereby allowing a more efficient processing.

In the approach described above, the auxiliary subband artificial neural networks are all provided with the same set of feature values. In some embodiments, only some of the auxiliary subband artificial neural networks may be provided with the same set of feature values. However, using the same set of feature values may in many embodiments provide improved efficiency and performance. It may often reduce complexity and resource usage in generating the set of feature values. Further, in many scenarios it may provide improved operation and that all the available information provided by the feature values may be considered by each auxiliary subband artificial neural network, and thus improved adaptation of the auxiliary subband artificial neural network may be achieved.

However, in some embodiments, different artificial neural networks may be provided with different sets of feature values. For example, the first artificial neural network 107 may generate a set of feature data values and different subsets of these may be provided to different auxiliary subband artificial neural networks. In other embodiments, some feature sets may also be generated to include some feature values that are e.g. provided manually or generated by an analysis of the downmix audio signal. For example, harmonics or peaks may be detected in the downmix audio signal. Such data may e.g. only be applied to some of the auxiliary subband artificial neural networks. For example, detected peaks or harmonics may only be indicated to the auxiliary subband artificial neural networks of the subbands in which they are detected.

In many embodiments, different auxiliary subband artificial neural networks may thus be provided with different sets of feature values. In many cases, this may include some feature values being the same and some feature values being different for different sets of auxiliary subband artificial neural networks.

In the approach described above, a single first artificial neural network 107 is used to generate feature values for the sets of feature values whereas multiple auxiliary subband artificial neural networks process subband downmix audio signals.

In other embodiments, the generation of the sets of feature values may be subband based. In some embodiments, a separate filterbank may be applied to the downmix audio signal to provide a set of subband signals that are then fed to corresponding subband artificial neural networks that each generate a set of feature values. Such multiple artificial neural networks will also be referred to as feature set artificial neural networks. The sets of features generated by the feature set artificial neural networks may then be fed to the auxiliary subband artificial neural networks. The subbands generated by such a filter bank need not be the same as those generated by the filterbank 401 generating subband samples for the auxiliary subband artificial neural networks. For example, each of the subbands for determining features sets may include a different number of subbands for the auxiliary subband artificial neural networks and the feature sets determined by one feature set artificial neural network may be fed to the appropriate auxiliary subband artificial neural networks.

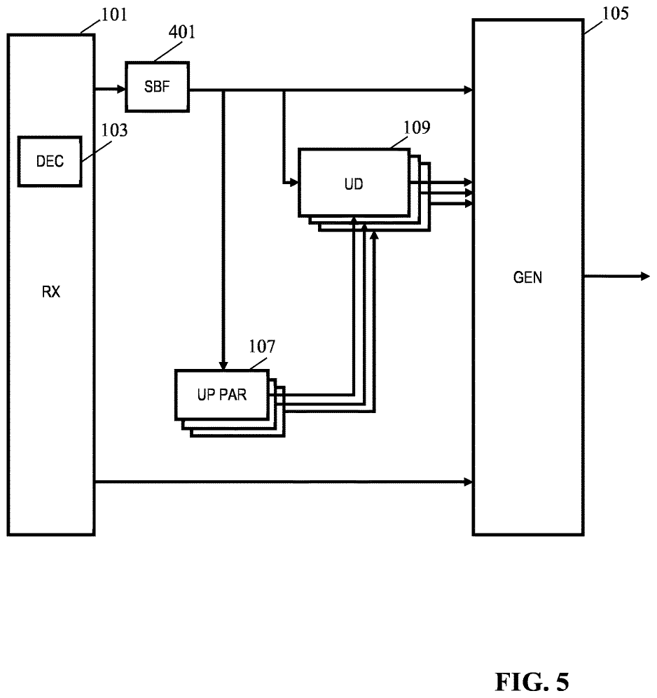

However, in many embodiments, the subbands used for the feature generation may be the same as the subband used for the auxiliary subband artificial neural networks. FIG. 5 illustrates an example of such an approach. In this example, rather than a single first artificial neural network 107 generating a set of feature values, the apparatus of FIG. 1 is modified to include a plurality of artificial neural networks that each generate a set of feature values.

The comments previously provided with respect to the first artificial neural network 107 will mutatis mutandis also apply to the feature set artificial neural networks, indeed the first artificial neural network 107 may be considered to be one of the feature set artificial neural networks.

In the approach, each of the feature set artificial neural networks generate a set of feature values that is applied only to a subset of the auxiliary subband artificial neural networks. Indeed, in many embodiments, each of the feature set artificial neural networks may generate a set of feature values for one of the auxiliary subband artificial neural networks. In some embodiments, the apparatus may include the same number of feature set artificial neural networks and auxiliary subband artificial neural networks, and specifically for each subband of the filterbank 401 there may be one feature set artificial neural network and one auxiliary subband artificial neural network. In other embodiments, there may be a different number of feature set artificial neural networks and auxiliary subband artificial neural networks. For example, one feature set artificial neural network may receive input samples for a group of subbands and generate a set of feature values for this group of subbands. This set of feature values may then be applied to the group of the auxiliary subband artificial neural networks for these subbands.

Such a subband based approach for generating sets of feature values may in many scenarios provide improved results by allowing a more accurate set of feature values to be generated and used to adapt the auxiliary subband artificial neural networks. It may also in many scenarios reduce complexity and/or resource usage. For example, fewer values in the sets of feature values may be achieved in many embodiments thereby allowing reduction of complexity of both the feature set artificial neural networks and the auxiliary subband artificial neural networks. Further, typically, the feature set artificial neural networks will have less inputs and be much smaller than an artificial neural network covering the entire bandwidth.

In many such embodiments, each of the feature set artificial neural networks may generate a set of feature values for a given subset of subbands, and typically for a single subband, based on subband samples of that subset of subbands. However, in addition, one or more of the feature set artificial neural networks may in addition include subbands that are from one or more other subbands, i.e. the input to the feature set artificial neural network may have an input node that receives a subband sample for a subband for which the feature set artificial neural network does not generate any set of feature values.

As a specific example, in many embodiments, each feature set artificial neural network may as input receive subsamples from not only the subband for which it generates a set of feature values but also from say the neighboring subbands.

Such approaches may often allow an improved set of feature values to be generated which may lead to improved audio quality. In particular, it has been found that considering surrounding subbands may allow the set of feature values to better reflect temporal resolution of the downmix audio signal/multichannel audio signal. It has been found that such an approach may in particular allow a better representation of temporal peakedness.

In some embodiments, one or more of the feature set artificial neural networks, or indeed the first artificial neural network 107 in cases of only one such artificial neural network being included, may further as an input include subband samples from outside the time interval for which the corresponding auxiliary subband artificial neural network generates samples of the auxiliary audio signal. In particular, the processing of the audio apparatus operates on a frame by frame basis where a time interval/frame of the received downmix audio signal is processed to generate output samples for the multichannel audio signal for that time interval/frame. Thus, for each frame, the filterbank 401 generates subband samples, these are fed to the feature set artificial neural networks which generate sets of feature values for the time interval, and to the feature set artificial neural networks which based on the subbands and the set of feature values generate subband samples of the subband representation of the multichannel audio signal.

Thus, in particular, each feature set artificial neural network operates in block form with each operation where a set of output samples are generated from a set of input samples correspond to a time interval of the downmix audio signal/multichannel audio signal for which output samples of the multichannel audio signal are generated.

In some embodiments, one or more of the feature set artificial neural networks may in addition to the appropriate subband samples that are generated for the current time interval also receive subband samples for another time interval, such as typically from one or more neighbor time intervals. For example, in some embodiments, one or more of the feature set artificial neural networks may also include the subband samples for the previous and next time interval.

In many embodiments, such an approach may provide improved sets of feature values to be generated leading to improved audio quality.

Artificial neural networks are adapted to specific purposes by a training process which are used to adapt/tune/modify the weights and other parameters (e.g. bias) of the artificial neural network. It will be appreciated that many different training processes and algorithms are known for training artificial neural networks. Typically, training is based on large training sets where a large number of examples of input data are provided to the network. Further, the output of the artificial neural network is typically (directly or indirectly) compared to an expected or ideal result. A cost function may be generated to reflect the desired outcome of the training process. In a typical scenario known as supervised learning, the cost function often represents the distance between the prediction and the ground truth for a particular input data. Based on the cost function, the weights may be changed and by reiterating the process for the modified weights, the artificial neural network may be adapted towards a state for which the cost function is minimized.

In more detail, during a training step the neural network may have two different flows of information from input to output (forward pass) and from output to input (backward pass). In the forward pass, the data is processed by the neural network as described above while in the backward pass the weights are updated to minimize the cost function. Typically, such a backward propagation follows the gradient direction of the cost function landscape. In other words, by comparing the predicted output with the ground truth for a batch of data input, one can estimate the direction in which the cost function is minimized and propagate backward, by updating the weights accordingly. Other approaches known for training artificial neural networks include for example Levenberg-Marquardt algorithm, the conjugate gradient method, and the Newton method etc.

In the present case, training may specifically include a training set comprising a potentially large number of multichannel audio signals or corresponding downmix audio signals. The training sets may include audio signals representing a number of different audio sources including e.g. recording of videos, movies, telecommunications, etc. In some embodiments, the training data may even include non-audio data such as a training being performed in combination with training data from other sources, such as text data etc.

In some embodiments, training data may be multichannel audio signals in time segments corresponding to the processing time intervals of the artificial neural networks being trained, e.g. the number of samples in a training multichannel audio signal may correspond to a number of samples corresponding to the input nodes of the artificial neural network(s) being trained. Each training example may thus correspond to one operation of the artificial neural network(s) being trained. Usually, however, a batch of training samples is considered for each step to speed up the training process. Furthermore, many upgrades to gradient descent are possible also to speed up convergence or avoid local minima in the cost function landscape.

For each training multichannel audio signal, a training processor may perform a downmix operation to generate a downmix audio signal and corresponding upmix parametric data. Thus, the encoding process that is applied to the multichannel audio signal during normal operation may also be applied to the training multichannel audio signal thereby generating a downmix and the upmix parametric data.

In addition, the training processor may in some embodiments generate a residual signal which reflects the difference between the downmix audio signal and the multichannel audio signal, or more typically represents the part of the multichannel audio signal not properly represented by the downmix audio signal. For example, in many embodiments the training processor may generate a downmix signal and in addition may generate a residual signal which when used in an upmixing based on the upmix parametric data will result in a (more) accurate multichannel audio signal to be reconstructed.

Specifically, for a stereo multichannel audio signal, the training processor may use a Parametric Stereo scheme (e.g. in accordance with a suitable standardized approach). Such an encoding will apply a frequency- and time-dependent matrix operation, e.g. a rotation operation to the input stereo signal to generate a downmix signal and a residual signal. For example, typically a 2×2 matrix multiplication/complex value multiplication is applied to the input stereo signals to e.g. substantially align one of the rotated channel signals to have a maximum signal value. This channel may be used as the mono-signal and the rotation is typically performed on a frame basis. The rotation value may be stored as part of the upmix parametric data (or a parameter allowing this to be determined may be included in the upmix parametric data). Thus, in a synthesis apparatus, the opposite rotation may be performed to reconstruct the stereo signal. The rotation of the stereo signal results in another stereo signal of which one channel is accordingly aligned with the maximum intensity. The other channel is typically discarded in a Parametric Stereo encoder in order to reduce the data rate. In conventional PS decoding, a decorrelated signal is typically generated at the decoder and used for the upmixing process. In the current training approach this second signal may be used as a residual signal for the downmixing as it may represent the information discarded in the encoder, and thus it represents the ideal signal to be reconstructed in the decoder as part of an upmixing process.

Thus, in some embodiments, a training processor may from training multichannel audio signals generate training downmix signals and/or training residual signals. The training downmix signals may be fed to the arrangement of the first artificial neural network 107 and the second artificial neural network 109, or equivalently to the feature set artificial neural networks and auxiliary subband artificial neural networks arrangements, i.e. the samples of the training downmix audio signal is fed to the neural networks using the same processing as that applied to the downmix audio signal by the audio apparatus during normal operation (e.g. including subband filtering etc).

An output from the neural network operation is then determined and a cost function is applied to determine a cost value for each training downmix audio signal and/or for the combined set of training downmix audio signals (e.g. an average cost value for the training sets is determined). The cost function may include various components.

Typically, the cost function will include at least one component that reflects how close a generated signal is to a reference signal, i.e. a so-called reconstruction error. In some embodiments the cost function will include at least one component that reflects how close a generated signal is to a reference signal from a perceptual point of view.

For example, in some embodiments, the auxiliary audio signal generated by the second artificial neural network 109 for a given training downmix audio signal/multichannel audio signal may be compared to the residual signal for that training downmix audio signal/multichannel audio signal. A cost function contribution/combination may be generated that reflects the difference between the generated auxiliary audio signal and the reference residual signal. This process may be generated for all training sets to generate an overall cost function.

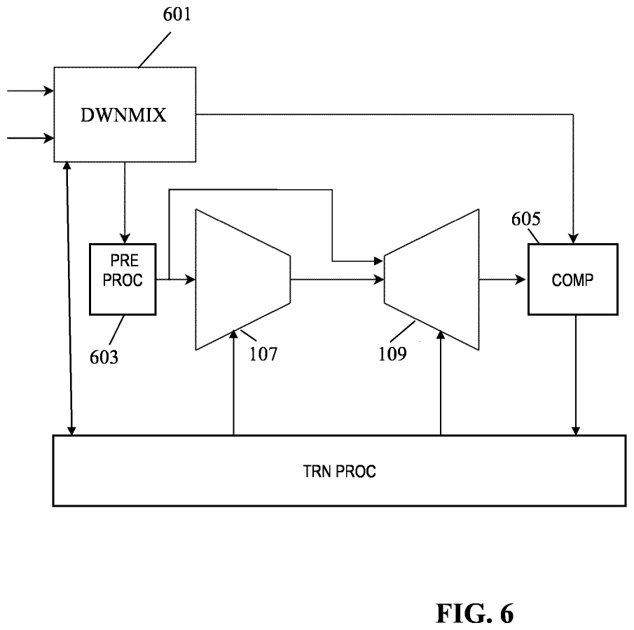

Such an example is illustrated in FIG. 6. In the example, a downmixer 601 may receive training multichannel audio signals, which in the specific example are stereo signals. For a given training signal, the downmixer 601 performs a downmixing operation to generate a training downmix signal, which in the specific example is a training mono audio signal and a residual signal. The downmix audio signal is fed to a preprocessor 603 which specifically may generate downmix audio signal samples for being input to the artificial neural networks. The preprocessor 603 specifically performs the same operations as are performed in the synthesis apparatus to generate samples for the artificial neural networks, and indeed typically the same functionality may be used, i.e. the decoder functions to generate the artificial neural network input samples are also used during the training process. In addition, the preprocessor 603 may include functionality corresponding to the encoder/decoding process of the training downmix audio signal, including for example quantization etc.

The output of the preprocessor 603 is fed to the first artificial neural network 107 and the second artificial neural network 109 in the same way as in the audio apparatus of FIG. 1. The first artificial neural network 107 and second artificial neural network 109 are coupled to each other such that the output set of feature values generated by the first artificial neural network 107 are fed to the second artificial neural network 109. The output of the second artificial neural network 109 thus corresponds to samples of the auxiliary audio signal generated for the training downmix audio signal.

Thus, for a given training multichannel audio signal, the training system of FIG. 6 performs the same operations as the audio apparatus of FIG. 1 thereby generating an auxiliary audio signal that would be generated by the audio apparatus if the artificial neural networks had the same data/configuration (coefficients, bias, etc).

The output of the second artificial neural network 109 is fed to a comparator 605 which proceeds to compare the generated auxiliary audio signal to the residual signal generated by the downmixer 601. As mentioned, the residual signal would in principle allow substantially perfect reconstruction of the multichannel audio signal and can accordingly be considered a close approximation of the ideal auxiliary audio signal. The comparison between the generated auxiliary audio signal and the residual signal thus provides an indication of how advantageous the generated auxiliary audio signal is. A cost value may accordingly be determined based on the comparison, and specifically the higher the difference the higher the cost value.

It will be appreciated that many different approaches may be used to determine the cost value reflecting difference between the signals. For example, a correlation may be performed with the cost value having a monotonically decreasing value for the increasing correlation value. As another example, the two signals may be subtracted from each other and a power measure for the difference signal may be used as a cost value. It will be appreciated that many other approaches are available and may be used.

Thus, in the example, the cost function generates a cost value that reflects how closely the generated auxiliary audio signals match the corresponding residual signals for the training multichannel audio signals.

Based on the cost value, the training processor 607 may adapt the weights of the artificial neural networks. For example, a back-propagation approach may be used. In particular, the training processor 607 may adjust the weights of both the first artificial neural network 107 and the second artificial neural network 109 based on the cost value. For example, given the derivative (representing the slope) of the weights with respect to the cost function the weights values are modified to go in the direction of the slope. For a simple/minima account one can refer to the training of the perceptron (single neuron) in case of backward pass of a single data input.

The process may be iterated until the artificial neural networks are considered to be trained. For example, training may be performed for a predetermined number of iterations. As another example, training may be continued until the weights change be less than a predetermined amount. Also very common, a validation stop is implemented where the network is tested again a validation metric and stopped when reaching the expected outcome.

As a specific example, a stereo signal may be fed to a traditional PS downmix module, that generates both the downmix as well as the ideal residual signal, i.e., the residual signal that would allow for (near-) perfect reconstruction of the waveform at the decoder side. Using pairs of mono signals and residual signals, a first artificial neural network 107 generates a set of feature values that may represent that audio signal (frame). This set of feature values is with the mono audio signal fed to the second artificial neural network 109 which generates the auxiliary audio signal. When the artificial neural networks are sufficiently deep, this arrangement may be trained using e.g. an RMSE (Root Mean Square Error for the auxiliary audio signal relative to the residual signal) like cost-function, resulting in the artificial neural network arrangement learning what the auxiliary audio signal should be for a given mono audio signal.

In the arrangement the first artificial neural network 107 and the second artificial neural network 109 are accordingly jointly trained using the same downmix audio signal and cost function. The weights of both the first artificial neural network 107 and second artificial neural network 109 are updated based on the same training data and the same cost function and downmix audio signal.

In many embodiments, the residual signal may be used directly when comparing to the generated auxiliary audio signal. However, more generally a target audio signal generated from the residual audio signal may be generated and used in the comparison to the generated auxiliary audio signal. The target audio signal may be generated by applying a function or signal processing application to the residual signal. For example, a scaling/level setting of the residual audio signal may be applied to generate a target audio signal. As another example, a filter operation may be applied to the residual audio signal to generate the target audio signal. As another example, scaling may be applied to the residual signal to minimize the difference to the generated auxiliary audio signal and/or maximize the correlation.

In some embodiments, the cost function may alternatively or additionally be arranged to reflect a difference between the training multichannel audio signal and a multichannel audio signal generated by upmixing the downmix audio signal and the generated auxiliary audio signal. In such an example, the downmixer 601 may also generate upmix parametric data which may be used in the upmixing. Thus, in some embodiments, rather than just train the artificial neural networks to generate an auxiliary audio signal that matches the residual signal, the training may include reconstruction of the multichannel audio signal based on the generated auxiliary audio signal. The generation of the output multichannel audio signal may specifically be performed using the same operations as those that will be performed in an encoder. This output multichannel audio signal may then be compared to the input multichannel audio signal.

In some embodiments, the cost function may further consider other parameters. For example, in some embodiments, the cost function may further include a consideration of a degree of correlation between the generated auxiliary audio signal and the downmix signal. In particular, the cost function may indicate a lower cost the more decorrelated the downmix audio signal and the auxiliary audio signal are. An increased decorrelation may indicate that less common information is present in both of the two signals.

In embodiments where a subband operation is performed, the described approach may be performed for each subband. Specifically, a residual audio signal may be generated for each subband and compared to the generated auxiliary audio signal subband samples for that subband. Thus, a cost function may be evaluated for each subband to determine a cost value and the coefficients of the feature set artificial neural network and auxiliary subband artificial neural network of that subband may be trained. In many embodiments, the feature set artificial neural networks, and/or indeed the first artificial neural network 107, may generate set of feature values that match the time and frequency resolution of the auxiliary subband artificial neural networks, including specifically the second artificial neural network 109 if only one artificial neural network is used. However, in other embodiments, the time and/or frequency resolution of the generated sets of feature values may differ, and typically the resolution may be lower for the sets of feature values. In such situations functionality may be included to modify the resolution. In particular, interpolators may be incorporated to generate interpolated sets of parameter values from the generated parameter values.

In some embodiments, one or more of the sets of feature values may in addition to the feature values generated by the feature set artificial neural networks also include one or more values that are generated in other ways.

Indeed, in some embodiments, a feature value may be included which reflects a user input. Specifically, the apparatus of FIGS. 1, 4 and 5 may include a user input and a user input processor which may be arranged to generate a feature value in response. Such an approach may allow a user to control or adapt the operation of the generation of the multichannel audio signal. For example, it may allow a specific audio mode to be selected which via the generation of the auxiliary audio signal may affect the reconstructed multichannel audio signal. The user inputs may relate to the perceptual audio quality manually and crafted by an expert. This additional terms might reduce the quantitative reconstruction of the audio, for example expressed as RMSE, but improve the audio reconstruction perception of humans.

Training of the auxiliary subband artificial neural networks may for example be performed in dependence on this feature set. For example, if the feature value may have a discrete number of possible values each of which corresponds to one user setting. Each of these settings may correspond to a desired variation of the multichannel audio signal. For example, one user input may have increased low and high frequencies, another may be filtered to only provide a mid-range, a third setting may have a high amount of reverberation or echo. During training the reference multichannel audio signal that is used for comparison in the cost function may be processed in accordance with the specific preference for the different settings. The network may then be trained for all possible settings of the user mode feature value but with the reference multichannel audio signal being selected as the one having been processed for that specific user mode feature value.

As another example, feature values may be generated in response to a different modality. For example, face detection may be used to identify a user and a feature value may be set to reflect the current user. This may allow automatic adaptation to the individual user.

In many embodiments, one or more of the feature values may be generated by an analysis of the downmix audio signal.

It will be appreciated that many different algorithms and procedures are known for analyzing an audio signal to extract or determine properties of the audio signal and that any suitable (analytical) approach, algorithm, and property may be used.

The audio apparatus(s) may specifically be implemented in one or more suitably programmed processors. In particular, the artificial neural networks may be implemented in one more such suitably programmed processors. The different functional blocks, and in particular the artificial neural networks, may be implemented in separate processors and/or may e.g. be implemented in the same processor. An example of a suitable processor is provided in the following.

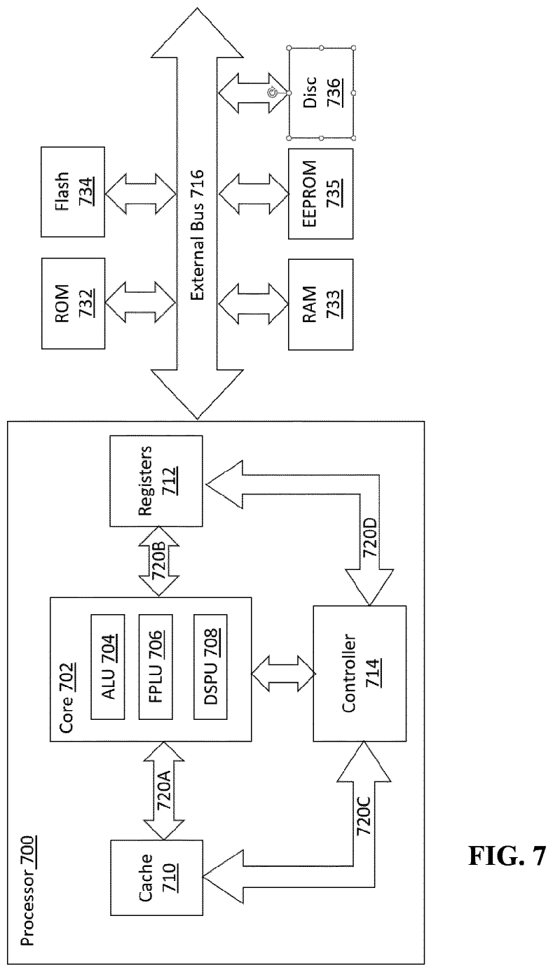

FIG. 7 is a block diagram illustrating an example processor 700 according to embodiments of the disclosure. Processor 700 may be used to implement one or more processors implementing an apparatus as previously described or elements thereof (including in particular one more artificial neural network). Processor 700 may be any suitable processor type including, but not limited to, a microprocessor, a microcontroller, a Digital Signal Processor (DSP), a Field ProGrammable Array (FPGA) where the FPGA has been programmed to form a processor, a Graphical Processing Unit (GPU), an Application Specific Integrated Circuit (ASIC) where the ASIC has been designed to form a processor, or a combination thereof.

The processor 700 may include one or more cores 702. The core 702 may include one or more Arithmetic Logic Units (ALU) 704. In some embodiments, the core 702 may include a Floating Point Logic Unit (FPLU) 706 and/or a Digital Signal Processing Unit (DSPU) 708 in addition to or instead of the ALU 704.

The processor 700 may include one or more registers 312 communicatively coupled to the core 702. The registers 712 may be implemented using dedicated logic gate circuits (e.g., flip-flops) and/or any memory technology. In some embodiments the registers 712 may be implemented using static memory. The register may provide data, instructions and addresses to the core 702.

In some embodiments, processor 700 may include one or more levels of cache memory 710 communicatively coupled to the core 702. The cache memory 710 may provide computer-readable instructions to the core 702 for execution. The cache memory 710 may provide data for processing by the core 702. In some embodiments, the computer-readable instructions may have been provided to the cache memory 710 by a local memory, for example, local memory attached to the external bus 716. The cache memory 710 may be implemented with any suitable cache memory type, for example, Metal-Oxide Semiconductor (MOS) memory such as Static Random Access Memory (SRAM), Dynamic Random Access Memory (DRAM), and/or any other suitable memory technology.

The processor 700 may include a controller 714, which may control input to the processor 700 from other processors and/or components included in a system and/or outputs from the processor 700 to other processors and/or components included in the system. Controller 714 may control the data paths in the ALU 704, FPLU 706 and/or DSPU 708. Controller 714 may be implemented as one or more state machines, data paths and/or dedicated control logic. The gates of controller 714 may be implemented as standalone gates, FPGA, ASIC or any other suitable technology.

The registers 712 and the cache 710 may communicate with controller 714 and core 702 via internal connections 720A, 720B, 720C and 720D. Internal connections may be implemented as a bus, multiplexer, crossbar switch, and/or any other suitable connection technology.

Inputs and outputs for the processor 700 may be provided via a bus 716, which may include one or more conductive lines. The bus 716 may be communicatively coupled to one or more components of processor 700, for example the controller 714, cache 710, and/or register 712. The bus 716 may be coupled to one or more components of the system.

The bus 716 may be coupled to one or more external memories. The external memories may include Read Only Memory (ROM) 732. ROM 732 may be a masked ROM, Electronically Programmable Read Only Memory (EPROM) or any other suitable technology. The external memory may include Random Access Memory (RAM) 733. RAM 733 may be a static RAM, battery backed up static RAM, Dynamic RAM (DRAM) or any other suitable technology. The external memory may include Electrically Erasable Programmable Read Only Memory (EEPROM) 735. The external memory may include Flash memory 734. The External memory may include a magnetic storage device such as disc 736. In some embodiments, the external memories may be included in a system.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. An apparatus comprising:
a receiver circuit,
wherein the receiver circuit is arranged to receive a downmix audio signal and an upmix parametric data,
wherein the downmix audio signal is arranged for a multichannel audio signal,
wherein the upmix parametric data is for upmixing the downmix audio signal;
a first artificial neural network,
wherein the first artificial neural network is arranged to generate a plurality of feature values for the downmix audio signal,
wherein the first artificial neural network has a plurality of first input nodes and a plurality of first output nodes,
wherein the plurality of first input nodes are arranged for receiving first samples of the downmix audio signal,
wherein the plurality of first output nodes are arranged to provide the plurality of feature values;
a second artificial neural network,
wherein the second artificial neural network has a plurality of second input nodes, a plurality of second output nodes and second nodes,
wherein the plurality of second input nodes are arranged to receive second samples of the downmix audio signal,
wherein the plurality of second output nodes are arranged to provide samples of an auxiliary audio signal for the downmix audio signal,
wherein the second nodes are arranged to receive feature values from the plurality of feature values; and
a generator circuit, wherein the generator circuit is arranged to generate the multichannel audio signal from the downmix audio signal and the auxiliary audio signal based on the upmix parametric data.

2. The apparatus of claim 1, further comprising a first filter bank,
wherein the first filter band is arranged to generate a frequency subband representation of the downmix audio signal,
wherein at least a portion of the second samples of the downmix audio signal are subband samples of the frequency subband representation of the downmix audio signal.

3. The apparatus of claim 2,
wherein the second artificial neural network is an artificial neural network of a first plurality of subband artificial neural networks,
wherein each subband artificial neural network of the first plurality of subband artificial neural networks is arranged to generate subband samples for a subset of subbands of a frequency subband representation of the auxiliary audio signal.

4. The apparatus of claim 3, wherein the first plurality of subband artificial neural networks comprises an artificial neural network for each subband of the frequency subband representation of the auxiliary audio signal.

5. The apparatus of claim 3,
wherein the generator circuit is arranged to generate a frequency subband representation of the multichannel audio signal by applying a subband matrix operation to the frequency subband representation of the auxiliary audio signal and the frequency subband representation of the downmix audio signal,
wherein the generator circuit is arranged to transform the frequency subband representation of the multichannel audio signal to a time domain representation of the multichannel audio signal.

6. The apparatus of claim 3, wherein the plurality of feature values generated by a subband artificial neural network of the second plurality of subband artificial neural networks is common for a plurality of subbands of the frequency subband representation of the downmix audio signal.

7. The apparatus of claim 2, wherein a portion of the plurality of second input nodes for artificial neural networks of the first plurality of subband artificial neural networks is monotonically decreasing for increasing frequency.

8. The apparatus of claim 1, further comprising a second filter bank,
wherein the second filter bank is arranged to generate a frequency subband representation of the downmix audio signal,
wherein at least a portion of the first samples of the downmix audio signal are subband samples of the frequency subband representation.

9. The apparatus of claim 8,
wherein the first artificial neural network is an artificial neural network of a second plurality of subband artificial neural networks,
wherein each subband artificial neural network of the second plurality of subband artificial neural networks is arranged to generate subband samples for a subset of artificial neural networks of the first plurality of artificial neural networks.

10. The apparatus of claim 9, wherein subband samples for at least one artificial neural network of the first plurality of artificial neural networks comprises a plurality of subband samples for multiple processing time intervals of an artificial neural network of the second plurality of subband artificial neural networks.

11. The apparatus of claim 9, wherein subband samples for at least one artificial neural network of the first plurality of subband artificial neural networks comprises at least one subband sample for a subband of the frequency subband representation of the downmix audio signal for which the at least one artificial neural network does not generate subband samples for the frequency subband representation of the auxiliary audio signal.

12. The apparatus of claim 1, wherein the first artificial neural network and the second artificial neural network are trained by a joint training process based on:
training data comprising pluralities of samples of a downmix audio signal generated by downmixing a training multichannel audio signal and a target audio signal determined from a residual signal generated for the downmix audio signal; and
using a cost function, wherein the cost function is indicative of a difference between a generated auxiliary audio signal for the training multichannel audio signal and the target audio signal.

13. The apparatus of claim 1, wherein the generator circuit is arranged to generate feature values for the plurality of feature values from analysis of the downmix audio signal.

14. A method comprising:
receiving a downmix audio signal and an upmix parametric data,
wherein the downmix audio signal is arranged for a multichannel audio signal,
wherein the upmix parametric data is for upmixing the downmix audio signal;
generating a plurality of feature values for the downmix audio signal;
receiving first samples of the downmix audio signal;
providing the plurality of feature values;
receiving second samples of the downmix audio signal;
providing samples of an auxiliary audio signal for the downmix audio signal;
receiving feature values from the plurality of feature values; and
generating the multichannel audio signal from the downmix audio signal and the auxiliary audio signal based on the upmix parametric data.

15. A computer program stored on a non-transitory medium, wherein the computer program when executed on a processor performs the method as claimed in claim 14.

16. The method of claim 14, further comprising generating a frequency subband representation of the downmix audio signal, wherein at least a portion of the second samples of the downmix audio signal are subband samples of the frequency subband representation of the downmix audio signal.

17. The method of claim 16, further comprising generating subband samples for a subset of subbands of a frequency subband representation of the auxiliary audio signal.

18. The method of claim 17, wherein a plurality of subband artificial neural networks comprises an artificial neural network for each subband of the frequency subband representation of the auxiliary audio signal.

19. The method of claim 16, further comprising:
generating a frequency subband representation of the multichannel audio signal by applying a subband matrix operation to the frequency subband representation of the auxiliary audio signal and the frequency subband representation of the downmix audio signal; and
transforming the frequency subband representation of the multichannel audio signal to a time domain representation of the multichannel audio signal.

20. The method of claim 16, wherein the plurality of feature values generated is common for a plurality of subbands of the frequency subband representation of the downmix audio signal.

21. The method of claim 16, wherein a portion of a plurality of input nodes for an artificial neural network of a first plurality of subband artificial neural networks is monotonically decreasing for increasing frequency.

22. The method of claim 14,
wherein at least a portion of the first samples of the downmix audio signal are subband samples of a frequency subband representation.

23. The method of claim 22, further comprising generating subband samples for a subset of artificial neural networks of a first plurality of artificial neural networks.

24. The method of claim 23, wherein subband samples comprises a plurality of subband samples for multiple processing time intervals of an artificial neural network of a first plurality of artificial neural networks.

25. The method of claim 23, wherein subband samples comprises at least one subband sample for a subband of the subband representation of the downmix audio signal for which at least one artificial neural network does not generate subband samples for the subband representation of the auxiliary audio signal.

26. The method of claim 14, further comprising generating feature values for the plurality of feature values from analysis of the downmix audio signal.

27. A method comprising training a first artificial neural network and a second artificial neural network based on:
training data comprising a plurality of samples of a downmix audio signal generated by downmixing a training multichannel audio signal and a target audio signal determined from a residual signal generated for the downmix audio signal; and
using a cost function, wherein the cost function is indicative of a difference between a generated auxiliary audio signal for the training multichannel audio signal and the target audio signal.
